(19) United States
(12) Patent Application Publication
(10) Pub. No.: US 2023/0379988 A1
(43) Pub. Date: Nov. 23, 2023

(54) Unmanned Aerial Vehicle And Controller Communication

(71) Applicant: QUALCOMM Incorporated, San Diego, CA (US)

(72) Inventors: Amar Kumar NANDAN, Hyderabad (IN); Rajat AGGARWAL, Hyderabad (IN); Ravneet SINGH, Hyderabad (IN); Mayank ARORA, Hyderabad (IN)

(21) Appl. No.: 18/247,931

(22) PCT Filed: Dec. 1, 2021
(86) PCT No.: PCT/US2021/061450

§ 371 Date: Apr. 5, 2023

(30) Foreign Application Priority Data
Dec. 11, 2020 (IN) 202021053929

(51) Int. Cl. H04W 76/12; H04W 4/38

(52) U.S. Cl. CPC H04W 76/12; H04W 4/38; H04W 84/06

(57) ABSTRACT

In embodiments of systems and methods for managing communication between an unmanned aerial vehicle (UAV) and an unmanned aerial vehicle controller (UAC), the UAV may receive from an unmanned aerial system traffic management (UTM) device a command request from the UAC, including one or more destination Generic Public Subscription Identifiers (GPSIs), a control command, a data command, and a first tunnel-to-add indication. The UAV may send to the UAV via the UTM device a command response, which may include information responsive to the command request, and a second tunnel-to-add indication. The UAV may establish an application layer communication tunnel with the UAC based on the first tunnel-to-add indication and the second tunnel-to-add indication. The communication tunnel may be configured to enable further communications with the UAC.

### RELATED APPLICATIONS

This application claims the benefit of priority to PCT Application US2021/061450 entitled “Unmanned Aerial Vehicle And Controller Communication” filed on Dec. 1, 2021, which claimed priority to Indian Provisional Patent Application No. 202021053929 entitled “Unmanned Aerial Vehicle And Controller Communication” filed on Dec. 11, 2020, the entire contents of both which are hereby incorporated by reference for all purposes.

### BACKGROUND

Unmanned aerial vehicles (UAVs, e.g., drones) and UAV controllers (UACs) can be provisioned to communicate via a direct radio frequency (RF) communication link. One aspect of Long Term Evolution (LTE) Fifth Generation (5G) New Radio (NR) network development includes the prospect of communicating with and controlling UAVs via 5G networks. An Unmanned Aerial System Traffic Management (UTM) is under development to function as a UAV traffic management ecosystem for UAV operations that is separate from, but complementary to, Air Traffic Management (ATM) systems. UTM development will ultimately identify services, roles and responsibilities, information architecture, data exchange protocols, software functions, infrastructure, and performance requirements for enabling the management of low-altitude uncontrolled drone operations. However, network communication resources are finite, and it is inefficient to continue to allocate network resources required to maintain a communication link between the UAV and the UAC in the event of little or no application-layer communication between the UAV and the UAC.

### SUMMARY

Various aspects include systems and methods performed by a processor of a UAV for managing communication with an unmanned aerial vehicle controller (UAC). Various aspects may include receiving from an unmanned aerial system traffic management (UTM) device a command request from the UAC, the command request including one or more destination Generic Public Subscription Identifiers (GPSIs), a control command, a data command, and a first tunnel-to-add indication, sending to the UAC via the UTM device a command response, the command response including information responsive to the command request, and a second tunnel-to-add indication, and establishing an application layer communication tunnel with the UAC based on the first tunnel-to-add indication and the second tunnel-to-add indication, wherein the application layer communication tunnel is configured to enable further communications with the UAC.

In some aspects, the control command may include a movement time and a movement type. Various aspects may further include executing the control command based on the movement time and movement type. In some aspects, the data command may include a data capture time, a data capture type, and a sensor type. Some aspects may further include capturing data based on the data capture time, the data capture type, and the sensor type.

In some aspects, the first tunnel-to-add indication may include a first transport layer address and a first port number. In such aspects, the second tunnel-to-add indication may include a second transport layer address and a second port number. In such aspects, establishing an application layer communication tunnel with the UAC based on the first tunnel-to-add indication and the second tunnel-to-add indication may include establishing the application layer communication tunnel with the UAC based on the first transport layer address, the first port number, the second transport layer address, and the second port number.

In some aspects, establishing an application layer communication tunnel with the UAC based on the first tunnel-to-add indication and the second tunnel-to-add indication may include capturing data based on the data command, establishing the application layer communication tunnel with the UAC based on the first tunnel-to-add indication and the second tunnel-to-add indication, and sending to the UAC the captured data via the established application layer communication tunnel. In some aspects, the command request may include a tunnel-to-release indication. In some aspects, the command response may include a tunnel-to-release indication.

Further aspects include a UAV having a processing system configured to perform one or more operations of any of the methods summarized above. Further aspects include processing devices for use in a UAVs configured with processor-executable instructions to perform operations of any of the methods summarized above. Further aspects include a non-transitory processor-readable storage medium having stored thereon processor-executable instructions configured to cause a processor of a UAV to perform operations of any of the methods summarized above. Further aspects include a UAV having means for performing functions of any of the methods summarized above. Further aspects include a system on chip for use in a UAV and that includes a processor configured to perform one or more operations of any of the methods summarized above.

Various aspects include systems and methods performed by a processor of an unmanned aerial vehicle controller (UAC) for managing communication with an unmanned aerial vehicle (UAV). Some aspects may include sending to an unmanned aerial system traffic management (UTM) device a command request for the UAV, the command request including a destination Generic Public Subscription Identifier (GPSI) list, a control command, a data command, and a first tunnel-to-add indication, receiving from the UTM device a command response from the UAV, the command response including information responsive to the command request, and a second tunnel-to-add indication, and establishing an application layer communication tunnel with the UAV based on the first tunnel-to-add indication and the second tunnel-to-add indication, wherein the application layer communication tunnel is configured to enable further communications with the UAV.

In some aspects, the control command may include a movement time and a movement type. In some aspects, the data command may include a data capture time, a data capture type, and a sensor type.

In some aspects, the first tunnel-to-add indication may include a first transport layer address and a first port number. In such aspects, the second tunnel-to-add indication may include a second transport layer address and a second port number. In such aspects, establishing an application layer communication tunnel with the UAV based on the first tunnel-to-add indication and the second tunnel-to-add indication may include establishing the application layer communication tunnel with the UAV based on the first transport layer address, the first port number, the second transport layer address, and the second port number.

In some aspects, the command request may include a tunnel-to-release indication or an indication of a number of tunnels to release. In some aspects, the command response may include a tunnel-to-release indication or an indication of a number of tunnels to release.

Further aspects include a UAC having a processing system configured to perform one or more operations of any of the methods summarized above. Further aspects include processing devices for use in a UACs configured with processor-executable instructions to perform operations of any of the methods summarized above. Further aspects include a non-transitory processor-readable storage medium having stored thereon processor-executable instructions configured to cause a processor of a UAC to perform operations of any of the methods summarized above. Further aspects include a UAC having means for performing functions of any of the methods summarized above. Further aspects include a system on chip for use in a UAC and that includes a processor configured to perform one or more operations of any of the methods summarized above.

### BRIEF DESCRIPTION OF THE DRAWINGS

FIG. 1 is a system block diagram illustrating an example communications system suitable for implementing any of the various embodiments.

FIG. 2A is a component block diagram illustrating an example computing and wireless modem system suitable for implementing any of the various embodiments.

FIG. 2B is a component block diagram illustrating examples component of a UAV suitable for implementing any of the various embodiments.

FIG. 3 is a component block diagram illustrating a software architecture including a radio protocol stack for the user and control planes in wireless communications suitable for implementing any of the various embodiments.

FIGS. 4A and 4B are component block diagrams illustrating a system 400 configured for managing communication between a UAV and a UAC according to various embodiments.

FIG. 5 is a message flow diagram illustrating a method 500 for managing communication between a UAV and a UAC according to various embodiments.

FIG. 6A is a process flow diagram illustrating a method performed by a processor of a UAV for managing communication with a UAC according to various embodiments.

FIGS. 6B and 6C illustrate operations that may be performed as part of the method 600a performed by a processor of a UAV for managing communication with a UAC according to various embodiments.

FIG. 7 is a process flow diagram illustrating a method that may be performed by a processor of a UAC for managing communication with a UAV according to various embodiments.

FIG. 8 is a component block diagram of a network computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include systems and methods performed by UAVs and UACs to dynamically establish an application layer (or data plane) communication link, such as an Internet Protocol (IP) tunnel, between a UAV and a UAC. Various embodiments may be used to establish and tear down an application layer communication link between the UAV and the UAC on-demand, while retaining the pairing and communication authorization between the UAV and the UAC.

While the description refers to a UAV for conciseness, it will be understood that a UAV may include one of various types of vehicles including an onboard computing device configured to provide some autonomous or semi-autonomous capabilities. Examples of such vehicles include but are not limited to: aerial vehicles, such as UAVs; ground vehicles (e.g., an autonomous or semi-autonomous car, a vacuum robot, etc.); water-based vehicles (i.e., vehicles configured for operation on the surface of the water or under water); and/or some combination thereof. In some embodiments, the vehicle may be manned. In other embodiments, the vehicle may be unmanned. In embodiments in which the vehicle is autonomous, the vehicle may include an onboard computing device configured to maneuver and/or navigate the vehicle without remote operating instructions (i.e., autonomously), such as from a human operator (e.g., via a remote computing device). In embodiments in which the vehicle is semi-autonomous, the vehicle may include an onboard computing device configured to receive some information or instructions, such as from a human operator (e.g., via a remote computing device), and autonomously maneuver and/or navigate the vehicle consistent with the received information or instructions. In some implementations, the vehicle may be an aerial vehicle (unmanned or manned), which may be a rotorcraft or winged aircraft. For example, a rotorcraft (also referred to as a multirotor or multicopter) may include a plurality of propulsion units (e.g., rotors/propellers) that provide propulsion and/or lifting forces for the vehicle. Specific non-limiting examples of rotorcraft include tricopters (three rotors), quadcopters (four rotors), hexacopters (six rotors), and octocopters (eight rotors). However, a rotorcraft may include any number of rotors. A vehicle may include a variety of components and/or payloads that may perform a variety of functions. The term “components” when used with respect to a vehicle includes vehicle components and/or vehicle payloads.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (WiFi), IEEE 802.16 (WiMAX), IEEE 802.20, Flash-OFDM, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Various embodiments include methods and UAVs and UACs configured to implement the methods of dynamically establishing an application layer (or data plane) communication link (e.g., an IP tunnel), between a UAV and a UAC. In various embodiments, the UAV and the UAV may establish and tear down an application layer communication link between the UAV and the UAC on-demand, while retaining the pairing and communication authorization between the UAV and the UAC.

In various embodiments, the procedure to establish the application layer communication link may be initiated by the UAV or the UAC. The UAV and the UAC may use the application layer communication link to send commands, data, and other such information. As an example, the UAV may record video of an event, and then initiate the establishment of the application layer communication link in order to send the video to the UAC. As another example, the UAC may initiate the establishment of the application layer communication link in order to send a flight command to the UAV. The UAV may operate autonomously when not receiving commands from the UAC. The UAC may also initiate the establishment of the application layer communication link in order to request that the UAV send sensor information, such as temperature, pressure, proximity, humidity, altitude, coordinate (e.g., latitude and longitude), etc.

As noted above, the procedure to establish the application layer communication link may be initiated by the UAV or the UAC. For conciseness, the following description includes operations initiated by the UAC. However, it will be appreciated that this is not a limitation, and that operations described as being performed by the UAC may be performed by the UAV, and vice versa.

In some embodiments, the UAV and the UAC may each perform a registration and pairing procedure with the UTM. Following completion of the registration and pairing procedure, the UAC may send a command request message for the UAV to the UTM. In some embodiments, the UAC may configure the command request message as an information element (e.g., SendCommandRequest), such as an information element in a non-access strata (NAS) packet data unit (PDU). In some embodiments, the command request may convey one or more specific commands, request information from the other device (e.g., the UAC may request information from the UAV, or vice versa), establish a communication link or data tunnel between the UAC and the UAV, or another suitable function.

In some embodiments, a sending device (e.g., a UAV or UAC) may send a command request to multiple devices (e.g., to multiple UAVs or UACs). In such embodiments, the UTM may process the command request and forward the command request to each destination device respectively. In some embodiments, multiple UACs may communicate with a single UAV. In such embodiments, the UTM may be configured to combine (e.g., aggregate, collate, or include) multiple commands for the UAV in a single message (or in one or more messages) and send the message(s) to the destination UAV. In some embodiments, the sending device may request a periodic response, as further described below.

In some embodiments, the command request message may be configured as a sequence of information and/or parameters. In some embodiments, the command request information element (e.g., SendCommandRequest) may include a reference to one or more parameters (e.g., CommandRequestInfo) that may be configured dynamically. In some embodiments, the command request (or command request parameters) may include one or more destination Generic Public Subscription Identifiers (GPSIs) (or one or more other suitable identifiers), a control command, a data command, a periodicity by which to send one or more messages and/or information, a tunnel-to-add indication, a tunnel-to-release indication, and/or a number of tunnel end points to release. In some embodiments, each of the elements of the command request message may be configured as information elements (e.g., DestinationGPSIList, controlCommand, dataCommand, Periodic, tunnelToAdd, tunnelToRelease, tunnelEndPointToRelease, etc.) and each may include an enumeration or indication of relevant information (e.g., a SEQUENCE (SIZE (1 . . . maxNodes), an ENUMERATED amount or integer, a SEQUENCE of amounts, and other suitable information).

The one or more destination GPSIs may indicate one or more UAVs, each associated with a GPSI, with which the UAC may be attempting to establish communication. The one or more destination GPSIs may be configured as an information element (e.g., DestinationGPSIList). In some embodiments, the control command may be configured as an information element (e.g., controlCommand). The control command may include a command or instruction to the UAV to perform an action, for example, a time or duration for performing a movement (e.g., a flight or navigation command and may be configured as an information element (e.g., movementTime). The control command may include a movement type (such as maneuver forward, backward, hover, ascend, descend, or another suitable command or instruction) and may be configured as an information element (e.g., movementType).

In some embodiments, the data command may be configured as an information element (e.g., dataCommand). The data command may be configured to include a command or instruction to the UAV to capture or obtain information, e.g., from one or more sensors of the UAV, such as audio, video, a still image (e.g., multiMediaDataCaptureType), temperature, pressure, humidity, other weather information, altitude, latitude and longitude, a proximity to an object (e.g., sensorDataCaptureType), and/or other suitable information. In some embodiments, the data command may include a time or time period at which to capture the sensor data (e.g., dataCaptureTime). In some embodiments, the data command may include a command or instruction to the UAV to send the sensor data to the UAC.

In some embodiments, the periodicity may be configured as an information element (e.g., Periodic). The periodicity may indicate a time to send information or a message, or a time period after which to send information or a message. For example, the periodicity may indicate or specify 1 millisecond (ms), 10 ms, 100 ms, 500 ms, 1 second (s), 10 seconds, 1 minute, 1 hour, 1 day, etc.

In some embodiments, a tunnel-to-add indication may include a command or instruction to the UAV to add a communication link between the UAC and the UAV. In some embodiments, the tunnel-to-add indication may include a transport layer address, a tunnel end point identifier (e.g., as an integer), a port number (e.g., a User Datagram Protocol (UDP) port number), and/or other information. In some embodiments, the tunnel-to-add indication may be configured as an information element (e.g., tunnelToAdd).

In some embodiments, the tunnel-to-release indication may include a tunnel end point identifier. In some embodiments, the tunnel-to-release indication may be configured as an information element (e.g., tunnelToRelease).

In some embodiments, the number of tunnel end points to release may be configured as an information element (e.g., tunnelEndPointToRelease). In some embodiments, the number of tunnel end points to release may be indicated as an integer.

In some embodiments, the UTM may perform a validation of one or more elements of the command request (e.g. with an Air Traffic Control system). If the one or more elements are validated, the UTM may then send a forwarded command request to the UAV. In some embodiments, the UTM may configure the forwarded command request as an information element (e.g., ForwardCommandRequest). In some embodiments, the forwarded command request may include one or more source GPSIs (e.g., based on a request to establish a communication link from one or more UACs), one or more elements from the data command (e.g., multiMediaDataCaptureType, sensorDataCaptureType, or another element), the tunnel-to-add indication, and the tunnel-to-release indication.

In some embodiments, the UAV may perform one or more actions based on the forwarded command request (e.g., perform a maneuver, capture sensor data, etc.). The UAV may then send a command response for the UAC to the UTM. In some embodiments, the UAV may send a command response message in response to the command request, which may include a request for a periodic response. In some embodiments, the command response may be sent to multiple devices. For example, the UAV may send information (which may be the same or different information) to multiple UACs. In some embodiments, the UTM may be configured to combine (e.g., aggregate, collate, or include) multiple command responses for one or more UACs in a single message (or in one or more messages) and send the message(s) to the UACs. In some embodiments, the UTM may be configured to determine whether to send a command response immediately to one or more UACs, or whether to combine multiple command responses from the UAV to a UAC.

In some embodiments, the command response may be configured as an information element (e.g., SendCommandResponse). In some embodiments, the command response information element may include a reference to one or more parameters (e.g., CommandResponseInfo) that may be configured dynamically. In some embodiments, the command response (or command response parameters) may include a destination GPSI list, a second tunnel-to-add indication, a second tunnel-to-release indication, and/or a second number of tunnel endpoints to release. In some embodiments, each of the elements of the command response message may be configured as information elements (e.g., GPSIList, tunnelToAdd, tunnelToRelease, tunnelEndPointToRelease, etc.) and each may include an enumeration of relevant information (e.g., SEQUENCE (SIZE (1 . . . maxNodes), an ENUMERATED amount or integer, a SEQUENCE of amounts, and other suitable information).

In some embodiments, the UTM may receive the command response, and prepare and send a forwarded command response to the UAC. In some embodiments, the UTM may configure the forwarded command response as an information element (e.g., ForwardCommandResponse). In some embodiments, the forwarded command response may include the destination GPSI list, the second tunnel-to-add indication, and the second tunnel-to-release indication. In some embodiments, each of the elements of the command response message may be configured as information elements (e.g., GPSIList, tunnelToAdd, tunnelToRelease, etc.) and each may include an enumeration of relevant information (e.g., SEQUENCE (SIZE (1 . . . maxNodes)).

Using the information in the forwarded command request, the UAV may perform operations to establish an application layer communication tunnel with the UAC. Using the information in the forwarded command response, the UAC may perform operations to establish the application layer communication tunnel with the UAV. The UAV and the UAC may send and/or receive further communications using the established application layer communication tunnel.

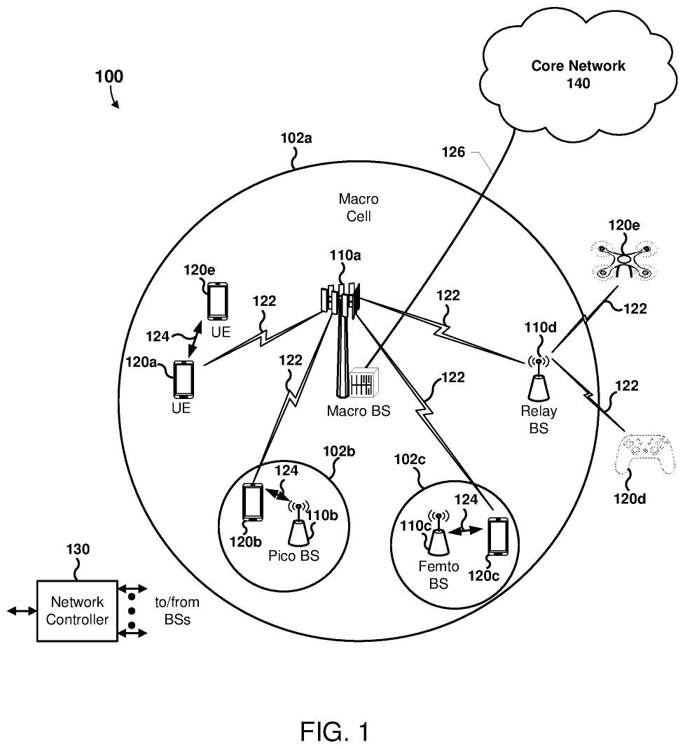

FIG. 1 is a system block diagram illustrating an example communications system 100. The communications system 100 may be a 5G New Radio (NR) network, or any other suitable network such as a Long Term Evolution (LTE) network. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of wireless devices (illustrated as wireless devices 120a-120e in FIG. 1, which may include a UAC 120d and a UAV 120e). The communications system 100 also may include a number of base stations (illustrated as the BS 110a, the BS 110b, the BS 110c, and the BS 110d) and other network entities. A base station is an entity that communicates with wireless devices, and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type core network, such as an LTE core network (e.g., an EPC network), 5G core network, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless devices 120a-120e may communicate with the base station 110a-110d over a wireless communication link 122. In some embodiments, the wireless

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 110d may communicate with the macro base station 110a and the wireless device 120d and/or 120e in order to facilitate communication between the base station 110a and the wireless device 120d and/or 120e. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, user equipment (UE), etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported.

Aggregation of multiple cells may be supported with up to eight serving cells. Alternatively, NR may support a different air interface, other than an OFDM-based air interface.

Some wireless devices may be considered machine-type communication (MTC) or evolved or enhanced machine-type communication (eMTC) wireless devices. MTC and eMTC wireless devices include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband internet of things) devices. The wireless device 120a-120e may be included inside a housing that houses components of the wireless device 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more wireless devices (for example, illustrated as the wireless device 120a and the wireless device 120e) may communicate directly using one or more sidelink channels (for example, without using a base station 110a-d as an intermediary to communicate with one another). For example, the wireless devices 120a-e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a-110d.

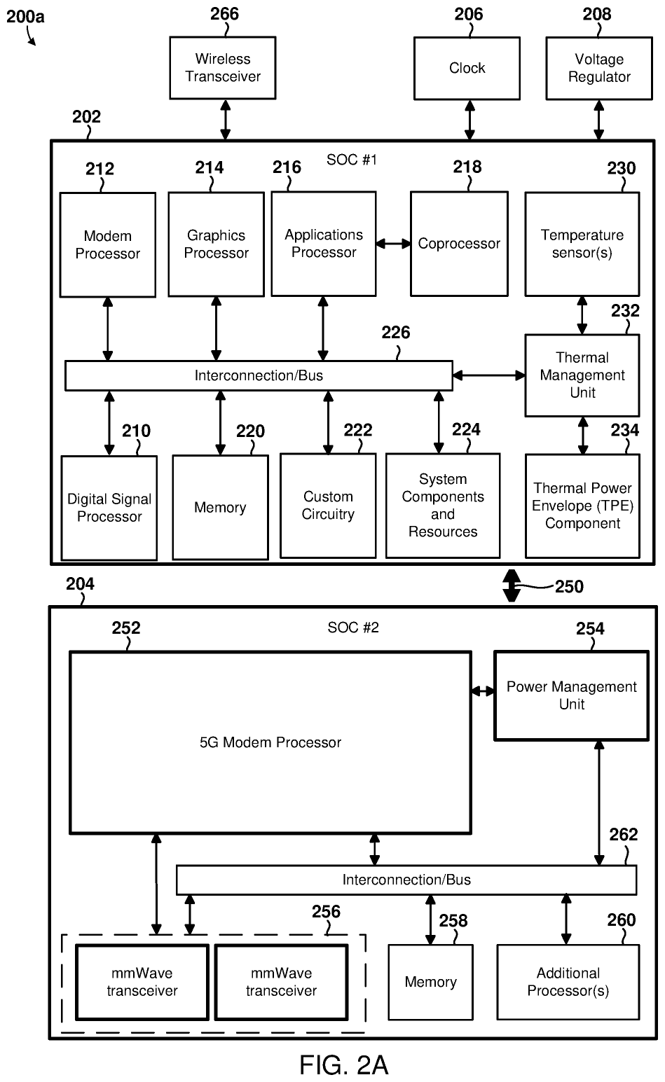

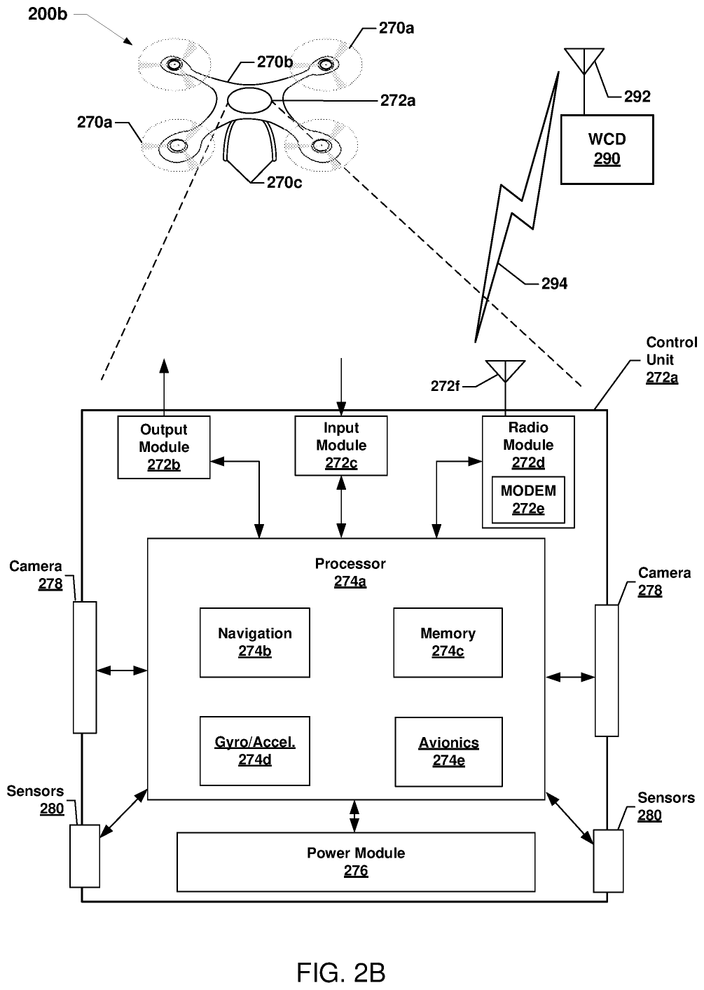

FIG. 2A is a component block diagram illustrating an example computing and wireless modem system 200a suitable for implementing any of the various embodiments. Various embodiments may be implemented on a number of single processor and multiprocessor computer systems, including a system-on-chip (SOC) or system in a package (SIP).

With reference to FIGS. 1 and 2A, the illustrated example computing system 200a (which may be a SIP in some embodiments) includes a two SOCs 202, 204 coupled to a clock 206, a voltage regulator 208, and a wireless transceiver 266 configured to send and receive wireless communications via an antenna (not shown) to/from wireless devices, such as a base station 110a. In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 262, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 262. The interconnection/bus module 226, 250, 262 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example computing system 200a discussed above, some implementations may be implemented in a wide variety of computing systems, which may include a single processor, multiple processors, multicore processors, or any combination thereof.

FIG. 2B is a component block diagram illustrating examples component of a UAV 200b suitable for implementing any of the various embodiments. With reference to FIGS. 1-2B, the UAV 200b may include a number of rotors 270a, a frame 270b, and landing columns 270c or skids. The frame 270b may provide structural support for the motors associated with the rotors 270a. The landing columns 270c may support the maximum load weight for the combination of the components of the UAV 200b and, in some cases, a payload. For ease of description and illustration, some detailed aspects of the UAV 200b are omitted such as wiring, frame structure interconnects, or other features that would be known to one of skill in the art. For example, while the UAV 200b is shown and described as having a frame 270b having a number of support members or frame structures, the UAV 200b may be constructed using a molded frame in which support is obtained through the molded structure. While the illustrated UAV 200b has four rotors 270a, this is merely exemplary and various embodiments may include more or fewer than four rotors 270a.

The UAV 200b may further include a control unit 272a that may house various circuits and devices used to power and control the operation of the UAV 200b. The control unit 272a may include a processor 274a, a power module 276, sensors 280, one or more cameras 278, an output module 272b, an input module 260, and a radio module 272d.

The processor 274a may be configured with processor-executable instructions to control travel and other operations of the UAV 200b, including operations of various embodiments. The processor 274a may include or be coupled to a navigation unit 274b, a memory 274c, a gyro/accelerometer unit 274d, and an avionics module 274e. The processor 274a and/or the navigation unit 274b may be configured to communicate with a server through a wireless connection (e.g., a cellular data network) to receive data useful in navigation, provide real-time position reports, and assess data.

The avionics module 274e may be coupled to the processor 274a and/or the navigation unit 274b, and may be configured to provide travel control-related information such as altitude, attitude, airspeed, heading, and similar information that the navigation unit 274b may use for navigation purposes, such as dead reckoning between Global Navigation Satellite System (GNSS) position updates. The gyro/accelerometer unit 274d may include an accelerometer, a gyroscope, an inertial sensor, or other similar sensors. The avionics module 274e may include or receive data from the gyro/accelerometer unit 274d that provides data regarding the orientation and accelerations of the UAV 200b that may be used in navigation and positioning calculations, as well as providing data used in various embodiments for processing images.

The processor 274a may further receive additional information from the sensors 280, such as an image sensor or optical sensor (e.g., a sensor capable of sensing visible light, infrared, ultraviolet, and/or other wavelengths of light). The sensors 280 may also include a radio frequency (RF) sensor, a barometer, a humidity sensor, a sonar emitter/detector, a radar emitter/detector, a microphone or another acoustic sensor, a lidar sensor, a time-of-flight (TOF) 3-D camera, or another sensor that may provide information usable by the processor 274a for movement operations, navigation and positioning calculations, and determining environmental conditions. The sensors 280 may also include one or more sensors configured to detect temperatures generated by one or more components of the robotic vehicle, such as thermometers, thermistors, thermocouples, positive temperature coefficient sensors, and other sensor components.

The power module 276 may include one or more batteries that may provide power to various components, including the processor 274a, the sensors 280, the one or more cameras 278, the output module 272b, the input module 260, and the radio module 272d. In addition, the power module 276 may include energy storage components, such as rechargeable batteries. The processor 274a may be configured with processor-executable instructions to control the charging of the power module 276 (i.e., the storage of harvested energy), such as by executing a charging control algorithm using a charge control circuit. Alternatively or additionally, the power module 276 may be configured to manage its own charging. The processor 274a may be coupled to the output module 272b, which may output control signals for managing the motors that drive the rotors 270a and other components.

The UAV 200b may be controlled through control of the individual motors of the rotors 270a as the UAV 200b progresses toward a destination. The processor 274a may receive data from the navigation unit 274b and use such data in order to determine the present position and orientation of the UAV 200b, as well as the appropriate course towards the destination or intermediate sites. In various embodiments, the navigation unit 274b may include a GNSS receiver system (e.g., one or more global positioning system (GPS) receivers) enabling the UAV 200b to navigate using GNSS signals. Alternatively or in addition, the navigation unit 274b may be equipped with radio navigation receivers for receiving navigation beacons or other signals from radio nodes, such as navigation beacons (e.g., very high frequency (VHF) omni-directional range (VOR) beacons), Wi-Fi access points, cellular network sites, radio station, remote computing devices, other robotic vehicles, etc.

The radio module 272d may be configured to receive navigation signals, such as signals from aviation navigation facilities, etc., and provide such signals to the processor 274a and/or the navigation unit 274b to assist in robotic vehicle navigation. In various embodiments, the navigation unit 274b may use signals received from recognizable RF emitters (e.g., AM/FM radio stations, Wi-Fi access points, and cellular network base stations) on the ground.

The navigation unit 274b may include a planning application that may perform calculations to plan a path of travel for the robotic vehicle within a volumetric space (“path planning”). In some embodiments, the planning application may perform path planning using information including information about aspects of a task to be performed by the robotic vehicle, information about environmental conditions, an amount of heat that may be generated by one or more components of the robotic vehicle in performing the task, as well as one or more thermal constraints.

The radio module 272d may include a modem 272e and a transmit/receive antenna 272f. The radio module 272d may be configured to conduct wireless communications via a variety of wireless communication devices (e.g., a wireless communication device (WCD) 290), examples of which include a wireless telephony base station or cell tower (e.g., a base station 110a), a network access point (e.g., an access point 110d), a beacon, a smartphone, a tablet, or another computing device with which the UAV 200b may communicate. The processor 274a may establish a bi-directional wireless communication link 294 via the modem 272e and the antenna 272f of the radio module 272d and the WCD 290 via a transmit/receive antenna 292. In some embodiments, the radio module 272d may be configured to support multiple connections with different wireless communication devices using different radio access technologies.

In various embodiments, the WCD 290 may be connected to a server through intermediate access points. In an example, the WCD 290 may be a server of a robotic vehicle operator, a third-party service (e.g., package delivery, billing, etc.), or a site communication access point. The UAV 200b may communicate with a server through one or more intermediate communication links, such as a wireless telephony network that is coupled to a wide area network (e.g., the Internet) or other communication devices. In some embodiments, the UAV 200b may include and employ other forms of radio communication, such as mesh connections with other robotic vehicles or connections to other information sources (e.g., balloons or other stations for collecting and/or distributing weather or other data harvesting information).

In various embodiments, the control unit 272a may be equipped with an input module 272c, which may be used for a variety of applications. For example, the input module 272c may receive images or data from an onboard camera 278 or sensors 280, or may receive electronic signals from other components (e.g., a payload).

While various components of the control unit 272a are illustrated as separate components, some or all of the components (e.g., the processor 274a, the output module 272b, the radio module 272d, and other units) may be integrated together in a single device or module, such as a system-on-chip module.

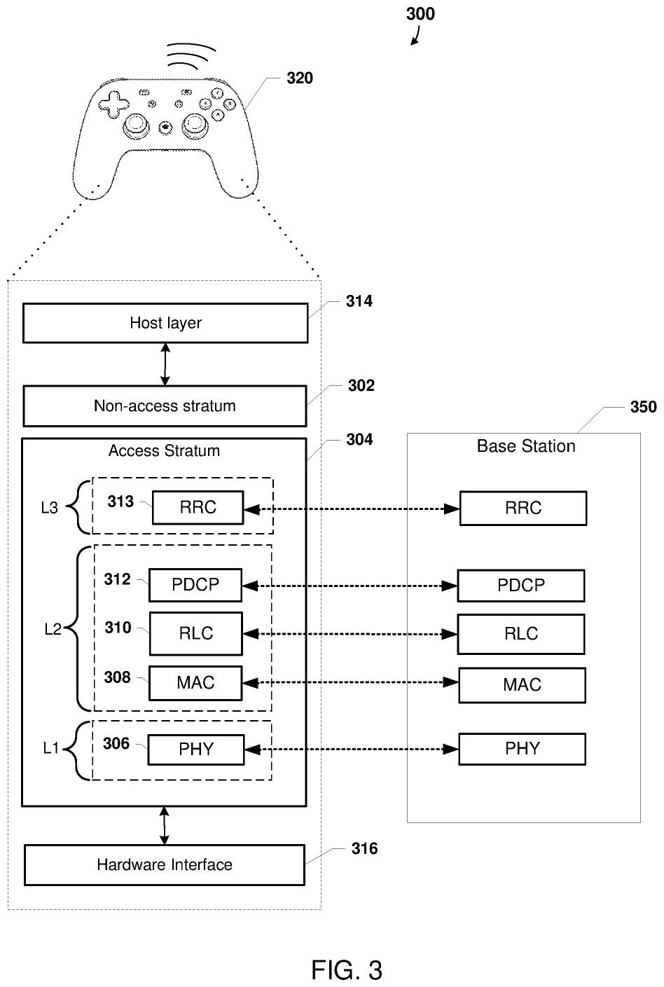

FIG. 3 is a component block diagram illustrating a software architecture 300 including a radio protocol stack for the user and control planes in wireless communications suitable for implementing any of the various embodiments. With reference to FIGS. 1-3, the wireless device 320 may implement the software architecture 300 to facilitate communication between a wireless device 320 (e.g., the wireless device 120a-120e, 200) and the base station 350 (e.g., the base station 110a-110d) of a communication system (e.g., 100). In various embodiments, the wireless device 320 may be configured as a UAC.

In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In some implementations, Layer 2 may include a media access control (MAC) sublayer 308, a radio link control (RLC) sublayer 310, and a packet data convergence protocol (PDCP) 312 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the wireless device 320 and the base station 350.

In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as Internet protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

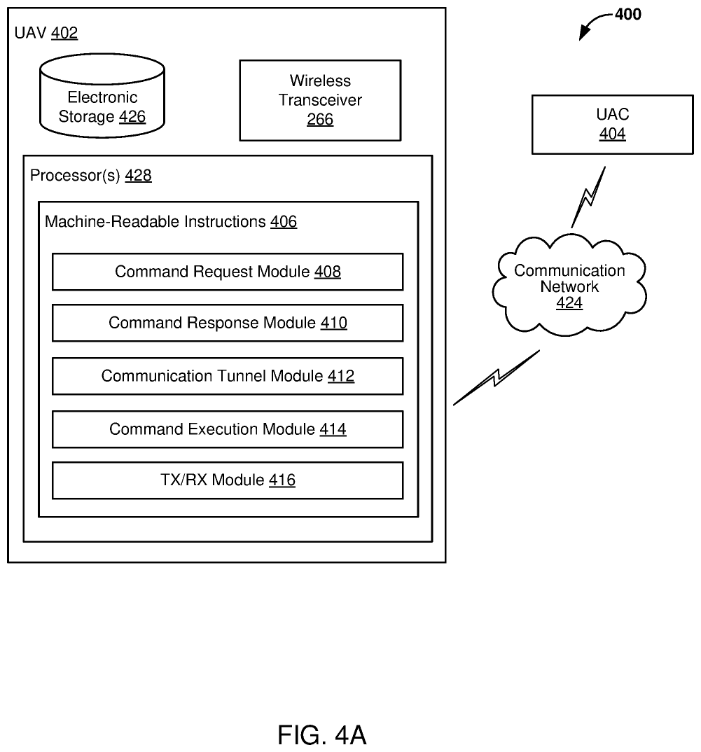

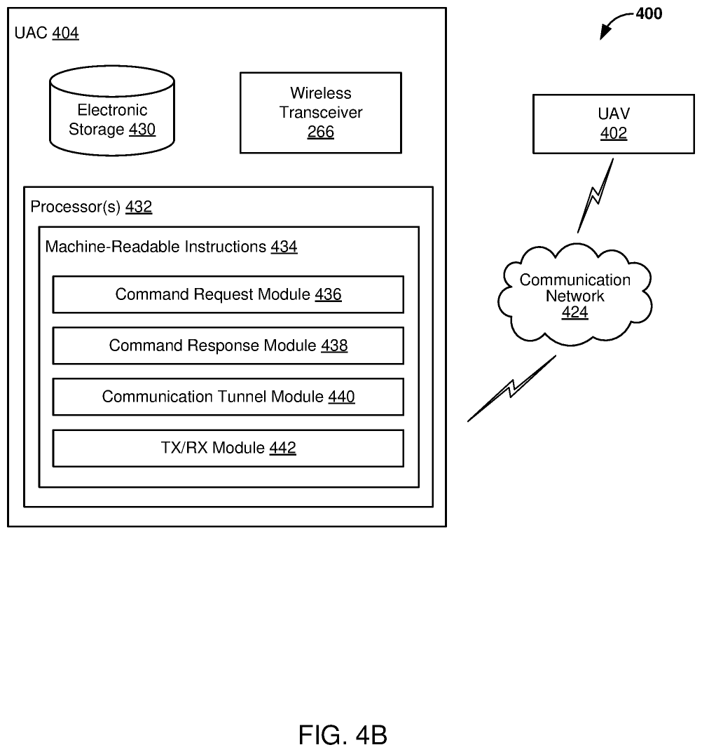

FIGS. 4A and 4B are component block diagrams illustrating a system 400 configured for managing communication between a UAV 402 and a UAC 404 according to various embodiments. With reference to FIGS. 1-4B, system 400 may include a UAV 402 (e.g., 120a-120e, 200a, 200b) and a UAC device 404 (e.g., 200a, 320).

The UAV 402 and the UAC 404 may include one or more processors 428, 432 coupled to electronic storage 426, 430 and a wireless transceiver (e.g., 266). In the UAV 402 and the UAC 404, the wireless transceiver 266 may be configured to receive messages sent in transmissions and pass such message to the processor(s) 428, 432 for processing. Similarly, the processor 428, 432 may be configured to send messages for transmission to the wireless transceiver 266 for transmission. The UAV 402 and the UAC 404 may communicate using signals conveyed by elements of a communication network 424, aspects of which are described with reference to FIG. 1.

Referring to the UAV 402, the processor(s) 428 may be configured by machine-readable instructions 406. Machine-readable instructions 406 may include one or more instruction modules. The instruction modules may include computer program modules. The instruction modules may include at least one or more of a command request module 408, a command response module 410, a communication tunnel module 412, a command execution module 414, and a transmit/receive (TX/RX) module 416.

The command request module 408 may be configured to receive from an unmanned aerial system traffic management (UTM) device a command request from the UAC. In some embodiments, the command request may include one or more destination Generic Public Subscription Identifiers (GPSIs), a control command, a data command, and a first tunnel-to-add indication.

The command response module 410 may be configured to send to the UAV via the UTM device a command response. In some embodiments, the command response may include information responsive to the command request, and a second tunnel-to-add indication.

The communication tunnel module 412 may be configured to establish an application layer communication tunnel with the UAC based on the first tunnel-to-add indication and the second tunnel-to-add indication. In some embodiments, the communication tunnel may be configured to enable further communications with the UAC.

The command execution module 414 may be configured to execute a command from the UAC. In some embodiments, the command may include a control command. In some embodiments, the command may include a data command.

The transmit/receive (TX/RX) module 416 may be configured to control the transmission and reception of wireless communications, e.g., via the wireless transceiver 266.

Referring to the UAC 404, the processor(s) 432 may be configured by machine-readable instructions 434. Machine-readable instructions 406 may include one or more instruction modules. The instruction modules may include computer program modules. The instruction modules may include at least one or more of a command request module 436, a command response module 438, a communication tunnel module 440, and a TX/RX module 442.

The command request module 436 may be configured to send to an unmanned aerial system traffic management (UTM) device a command request for the UAV. In some embodiments, the command request may include a destination Generic Public Subscription Identifier (GPSI) list, a control command, a data command, and a first tunnel-to-add indication.

The command response module 438 may be configured to receive from the UTM device a command response from the UAV. In some embodiments, the command response may include information responsive to the command request, and a second tunnel-to-add indication.

The communication tunnel module 440 may be configured to establish an application layer communication tunnel with the UAV based on the first tunnel-to-add indication and the second tunnel-to-add indication. In some embodiments, the communication tunnel may be configured to enable further communications with the UAV.

The TX/RX module 446 may be configured to control the transmission and reception of wireless communications, e.g., via the wireless transceiver 266.

In some embodiments, the UAV 402 and the UAC 404 may be operatively linked via one or more electronic communication links (e.g., wireless communication link 122, 124, 126). It will be appreciated that this is not intended to be limiting, and that the scope of this disclosure includes embodiments in which the UAV 402 and the UAC 404 may be operatively linked via some other communication medium.

The electronic storage 426, 430 may include non-transitory storage media that electronically stores information. The electronic storage media of electronic storage 426, 430 may include one or both of system storage that is provided integrally (i.e., substantially non-removable) with the UAV 402 and the UAC 404 and/or removable storage that is removably connectable to the UAV 402 and the UAC 404 via, for example, a port (e.g., a universal serial bus (USB) port, a firewire port, etc.) or a drive (e.g., a disk drive, etc.). Electronic storage 426, 430 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 426, 430 may include one or more virtual storage resources (e.g., cloud storage, a virtual private network, and/or other virtual storage resources). Electronic storage 426, 430 may store software algorithms, information determined by processor(s) 428, 432, information received from the base station 402 and the wireless device 404, or other information that enables the base station 402 and the wireless device 404 to function as described herein.

Processor(s) 428, 432 may be configured to provide information processing capabilities in the UAV 402 and the UAC 404. As such, the processor(s) 428, 432 may include one or more of a digital processor, an analog processor, a digital circuit designed to process information, an analog circuit designed to process information, a state machine, and/or other mechanisms for electronically processing information. Although the processor(s) 428, 432 are illustrated as single entities, this is for illustrative purposes only. In some embodiments, the processor(s) 428, 432 may include a plurality of processing units and/or processor cores. The processing units may be physically located within the same device, or processor(s) 428, 432 may represent processing functionality of a plurality of devices operating in coordination. The processor(s) 428, 432 may be configured to execute modules 408-416 and modules 436-442 and/or other modules by software; hardware; firmware; some combination of software, hardware, and/or firmware; and/or other mechanisms for configuring processing capabilities on processor(s) 428, 432. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 408-416 and modules 436-442 described below is for illustrative purposes, and is not intended to be limiting, as any of modules 408-416 and modules 436-442 may provide more or less functionality than is described. For example, one or more of the modules 408-416 and modules 436-442 may be eliminated, and some or all of its functionality may be provided by other modules 408-416 and modules 436-442. As another example, the processor(s) 428, 432 may be configured to execute one or more additional modules that may perform some or all of the functionality attributed below to one of the modules 408-416 and modules 436-442.

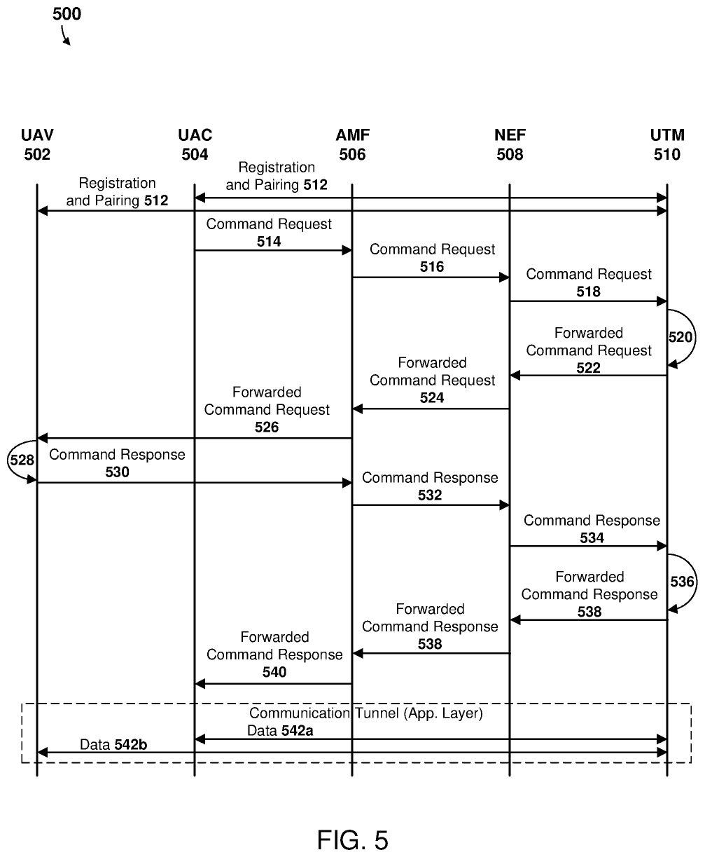

FIG. 5 is a message flow diagram illustrating a method 500 for managing communication between a UAV and a UAC according to various embodiments. With references to FIGS. 1-5, the operations of the method 500 may be performed by a processor (such as the processor 210, 212, 214, 216, 218, 252, 260, 428) of a UAV 502, a UAC 504, an Accessibility and Mobility Management Function (AMF) 506, a Network Exposure Function (NEF) 508, and a UTM 510.

In some embodiments, the UAC 504 may perform a registration and pairing procedure 512 with the UTM 510. The UAV 502 also may perform a registration and pairing procedure 514 with the UTM 510.

Following completion of the registration and pairing procedure 512, the UAC 504 may send a command request message 514 for the UAV 502 to the AMF 506. The AMF 506 may send the command request in a message 516 to the NEF 508. The NEF 508 may send the command request in a message 518 to the UTM 510.

In some embodiments, the UTM 510 may perform a validation 520 of one or more elements of the command request (e.g. with an Air Traffic Control system). If the one or more elements are validated, the UTM 510 may then send a forwarded command request 522 to the NEF 508. The NEF 508 may send the forwarded command request in a message 524 to the AMF 506. The AMF 506 may send the forwarded command request in a message 526 to the AMF UAV 502.

In some embodiments, the UAV may perform one or more actions 528 based on the forwarded command request (e.g., perform a maneuver, capture sensor data, etc.). The UAV 502 may then send a command response 530 for the UAC 504 to the AMF 506. The AMF 506 may send the command response in a message 532 to the NEF 508. The NEF 508 may send the command response in a message 534 to the UTM 510.

In some embodiments, the UTM may receive the command response and prepare 536 a response for the UAC. The UTM may send a forwarded command response 538 to the NEF. The NEF 508 may send the forwarded command response in a message 538 to the AMF 506. The AMF 506 may send the forwarded command response in a message 540 to the AMF UAV 502.

Using information (e.g., tunnel to add information), the UAV 502 and the UAC 504 may establish a communication tunnel, such as an application layer communication tunnel, via the UTM 510. In some embodiments, the UAC 504 may send and/or receive data communications 542a to and from the UAV 502 via the UTM 510, and the UAV 502 may send and/or receive data communications 542b to and from the UAC 504 via the UTM 510.

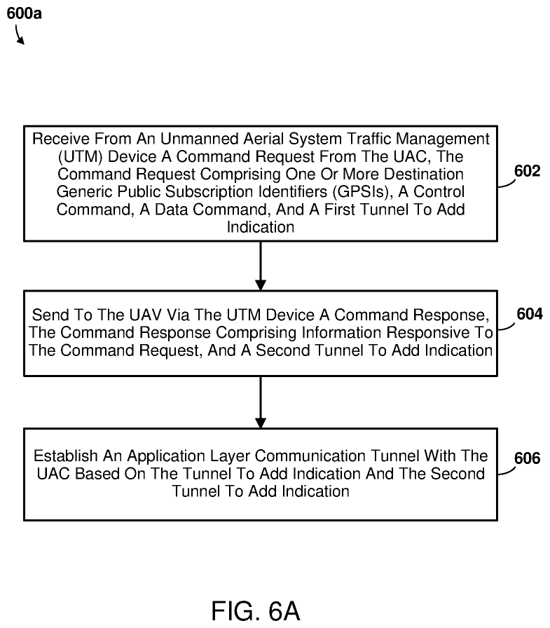

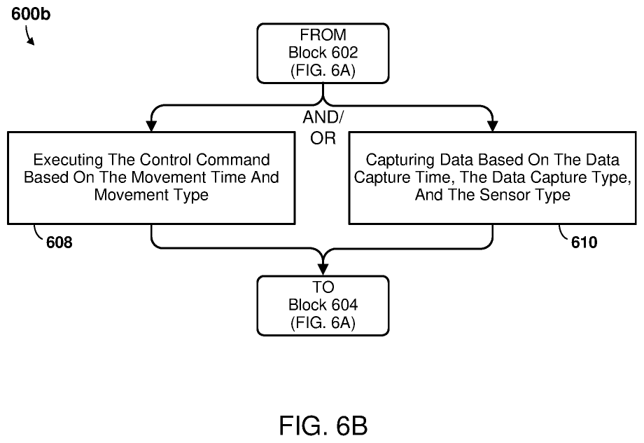

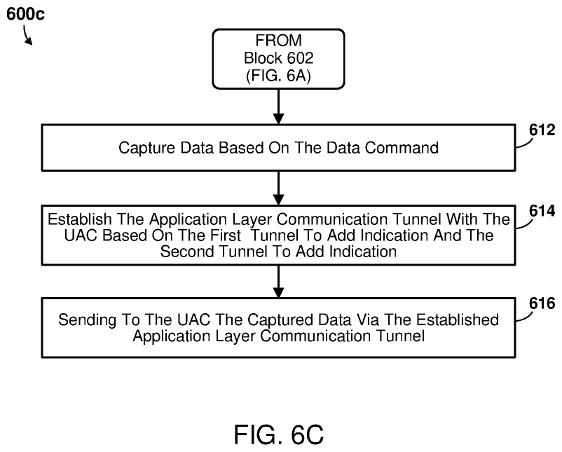

FIG. 6A is a process flow diagram illustrating a method 600a performed by a processor of a UAV for managing communication with a UAC according to various embodiments. With reference to FIGS. 1-6A, the operations of the method 600a may be performed by a processor (such as the processor 210, 212, 214, 216, 218, 252, 260, 428) of a UAV (such as the UAV 120a-120e, 200b, 402).

In block 602, the processor may receive from an unmanned aerial system traffic management (UTM) device a command request from the UAC. In some embodiments, the command request may include one or more destination Generic Public Subscription Identifiers (GPSIs), a control command, a data command, and a first tunnel-to-add indication. In some embodiments, the first tunnel-to-add indication received by the UAV may include a first transport layer address and a first port number. In some embodiments, the command request may include a tunnel-to-release indication. In some embodiments, the command request may include an indication of a number of tunnels to release. Means for performing functions of the operations in block 602 may include the processor (e.g., 210, 212, 214, 216, 218, 252, 260, 428) and the wireless transceiver (e.g., 266).

In block 604, the processor may send to the UAC via the UTM device a command response. In some embodiments, the command response may include information responsive to the command request, and a second tunnel-to-add indication. In some embodiments, the second tunnel-to-add indication may include a second transport layer address and a second port number. In some embodiments, the command response may include a tunnel-to-release indication. In some embodiments, the command response may include an indication of a number of tunnels to release. Means for performing functions of the operations in block 604 may include the processor (e.g., 210, 212, 214, 216, 218, 252, 260, 428) and the wireless transceiver (e.g., 266).

In block 606, the processor may establish an application layer communication tunnel with the UAC based on the first tunnel-to-add indication and the second tunnel-to-add indication. In some embodiments, the communication tunnel may be configured to enable further communications with the UAC. In some embodiments, the processor may establish the application layer communication tunnel with the UAC based on the first transport layer address and the first port number. Means for performing functions of the operations in block 606 may include the processor (e.g., 210, 212, 214, 216, 218, 252, 260, 428) and the wireless transceiver (e.g., 266).

FIGS. 6B and 6C illustrate operations 600b and 600c that may be performed as part of the method 600a performed by a processor of a UAV for managing communication with a UAC according to various embodiments.

Referring to FIG. 6B, following the performance of the operations of block 602 (FIG. 6A), the processor may execute the control command based on a movement time and movement type in block 608. In some embodiments, the control command may include a movement time and a movement type, and the processor may execute the control command based on a movement time and movement type. Means for performing functions of the operations in block 608 may include the processor (e.g., 210, 212, 214, 216, 218, 252, 260, 428).

Additionally or alternatively, the processor may capture data based on a data capture time, a data capture type, and a sensor type in block 610. In some embodiments, the control command may include a data capture time, a data capture type, and a sensor type, and the processor may capture the data based on the data capture time, the data capture type, and the sensor type. Means for performing functions of the operations in block 610 may include the processor (e.g., 210, 212, 214, 216, 218, 252, 260, 428).

Following the performance of the operations of block 608 and/or block 610, the processor may proceed to perform the operations of block 604 (FIG. 6A).

Referring to FIG. 6C, in some embodiments, the processor of the UAV may capture data based on the data command, and then establish the application layer communication tunnel with the UAC to transmit the captured data.

Following the performance of the operations of block 602 (FIG. 6A), the processor may capture data based on the data command in block 612. Means for performing functions of the operations in block 612 may include the processor (e.g., 210, 212, 214, 216, 218, 252, 260, 428) and a camera (e.g., 278) or a sensor (e.g., 280).

In block 614, the processor may establish the application layer communication tunnel with the UAC based on the first tunnel-to-add indication and the second tunnel-to-add indication. Means for performing functions of the operations in block 614 may include the processor (e.g., 210, 212, 214, 216, 218, 252, 260, 428) and the wireless transceiver (e.g., 266).

In block 616, the processor may send to the UAC the captured data via the established application layer communication tunnel. Means for performing functions of the operations in block 616 may include the processor (e.g., 210, 212, 214, 216, 218, 252, 260, 428) and the wireless transceiver (e.g., 266).

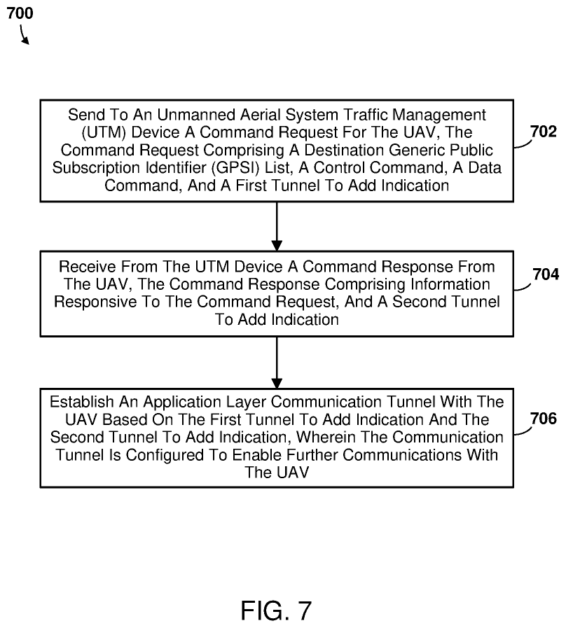

FIG. 7 is a process flow diagram illustrating a method 700 that may be performed by a processor of a UAC for managing communication with a UAV according to various embodiments. With reference to FIGS. 1-7, the operations of the method 700 may be performed by a processor (such as the processor 210, 212, 214, 216, 218, 252, 260, 432) of a UAC (such as the UAC 320, 404).

In block 702, the processor may send to an unmanned aerial system traffic management (UTM) device a command request for the UAV. In some embodiments, the command request may include a destination Generic Public Subscription Identifier (GPSI) list, a control command, a data command, and a first tunnel-to-add indication. In some embodiments, the control command may include a movement time and a movement type. In some embodiments, the data command may include a data capture time, a data capture type, and a sensor type. In some embodiments, the command request may include a tunnel-to-release indication. Means for performing functions of the operations in block 702 may include the processor (e.g., 210, 212, 214, 216, 218, 252, 260, 432) and the wireless transceiver (e.g., 266).

In block 704, the processor may receive from the UTM device a command response from the UAV. In some embodiments, the command response may include information responsive to the command request. In some embodiments, the command response may include a second tunnel-to-add indication. In some embodiments, the command response may include a tunnel-to-release indication. Means for performing functions of the operations in block 704 may include the processor (e.g., 210, 212, 214, 216, 218, 252, 260, 432) and the wireless transceiver (e.g., 266).

In block 706, the processor may establish an application layer communication tunnel with the UAV based on the first tunnel-to-add indication and the second tunnel-to-add indication. In some embodiments, the communication tunnel may be configured to enable further communications with the UAV. Means for performing functions of the operations in block 706 may include the processor (e.g., 210, 212, 214, 216, 218, 252, 260, 432) and the wireless transceiver (e.g., 266).

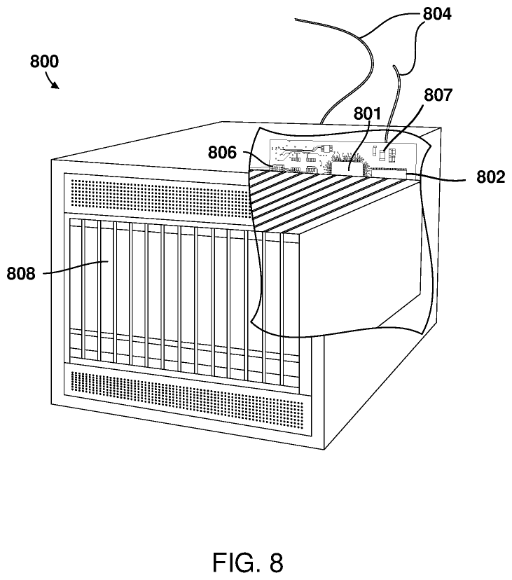

FIG. 8 is a component block diagram of a network computing device 800 suitable for use with various embodiments. Such network computing devices (e.g., the UTM 510, the NEF 508, the AMF 508) may include at least the components illustrated in FIG. 8. With reference to FIGS. 1-8, the network computing device 800 may typically include a processor 801 coupled to volatile memory 802 and a large capacity nonvolatile memory, such as a disk drive 808. The network computing device 800 also may include a peripheral memory access device 806 such as a floppy disc drive, compact disc (CD) or digital video disc (DVD) drive coupled to the processor 801. The network computing device 800 also may include network access ports 804 (or interfaces) coupled to the processor 801 for establishing data connections with a network, such as the Internet or a local area network coupled to other system computers and servers. The network computing device 800 may include one or more antennas 807 for sending and receiving electromagnetic radiation that may be connected to a wireless communication link. The network computing device 800 may include additional access ports, such as USB, Firewire, Thunderbolt, and the like for coupling to peripherals, external memory, or other devices.

The processor of the network computing device 800 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC (e.g., 204) dedicated to wireless communication functions and one processor within an SOC (e.g., 202) dedicated to running other applications. Software applications may be stored in the memory 802 before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a UAV including a processor configured with processor-executable instructions to perform operations of the methods of the following implementation examples; the example methods discussed in the following paragraphs implemented by a UAV comprising means for performing functions of the example methods; and the example methods discussed in the following paragraphs implemented as a non-transitory processor-readable storage medium having stored thereon processor-executable instructions configured to cause a processor of a UAV to perform the operations of the example methods.

Example 1. A method performed by a processor of an unmanned aerial vehicle (UAV) for managing communication with an unmanned aerial vehicle controller (UAC), comprising: receiving from an unmanned aerial system traffic management (UTM) device a command request from the UAC, the command request comprising one or more destination Generic Public Subscription Identifiers (GPSIs), a control command, a data command, and a first tunnel-to-add indication; sending to the UAC via the UTM device a command response, the command response comprising information responsive to the command request, and a second tunnel-to-add indication; and establishing an application layer communication tunnel with the UAC based on the first tunnel-to-add indication and the second tunnel-to-add indication, wherein the application layer communication tunnel is configured to enable further communications with the UAC.

Example 2. The method of example 1, wherein the control command comprises a movement time and a movement type.

Example 3. The method of example 2, further comprising executing the control command based on the movement time and movement type.

Example 4. The method of any of examples 1-3, wherein the data command comprises a data capture time, a data capture type, and a sensor type.

Example 5. The method of example 4, further comprising capturing data based on the data capture time, the data capture type, and the sensor type.

Example 6. The method of any of examples 1-5, wherein the first tunnel-to-add indication comprises a first transport layer address and a first port number, and wherein the second tunnel-to-add indication comprises a second transport layer address and a second port number; and establishing an application layer communication tunnel with the UAC based on the first tunnel-to-add indication and the second tunnel-to-add indication comprises establishing the application layer communication tunnel with the UAC based on the first transport layer address, the first port number, the second transport layer address, and the second port number.

Example 7. The method of any of examples 1-6, wherein establishing an application layer communication tunnel with the UAC based on the first tunnel-to-add indication and the second tunnel-to-add indication comprises capturing data based on the data command; establishing the application layer communication tunnel with the UAC based on the first tunnel-to-add indication and the second tunnel-to-add indication; and sending to the UAC the captured data via the established application layer communication tunnel.

Example 8. The method of any of examples 1-7, wherein the command request comprises a tunnel-to-release indication.

Example 9. The method of any of examples 1-8, wherein the command response comprises a tunnel-to-release indication.

Further implementation examples are described in the following paragraphs. While some of the following implementation examples are described in terms of example methods, further example implementations may include: the example methods discussed in the following paragraphs implemented by a UAC including a processor configured with processor-executable instructions to perform operations of the methods of the following implementation examples; the example methods discussed in the following paragraphs implemented by a UAC including means for performing functions of the example methods; and the example methods discussed in the following paragraphs implemented as a non-transitory processor-readable storage medium having stored thereon processor-executable instructions configured to cause a processor of a UAC to perform the operations of the example methods.

Example 10. A method performed by a processor of an unmanned aerial vehicle controller (UAC) for managing communication with an unmanned aerial vehicle (UAV), comprising: sending to an unmanned aerial traffic management (UTM) device a command request for the UAV, the command request comprising a destination Generic Public Subscription Identifier (GPSI) list, a control command, a data command, and a first tunnel-to-add indication; receiving from the UTM device a command response from the UAV, the command response comprising information responsive to the command request, and a second tunnel-to-add indication; and establishing an application layer communication tunnel with the UAV based on the first tunnel-to-add indication and the second tunnel-to-add indication, wherein the application layer communication tunnel is configured to enable further communications with the UAV.

Example 11. The method of method 10, wherein the control command comprises a movement time and a movement type.

Example 12. The method of any of methods 10 and 11, wherein the data command comprises a data capture time, a data capture type, and a sensor type

Example 13. The method of any of methods 10-12, wherein: the first tunnel-to-add indication comprises a first transport layer address and a first port number, and wherein the second tunnel-to-add indication comprises a second transport layer address and a second port number; and establishing an application layer communication tunnel with the UAV based on the first tunnel-to-add indication and the second tunnel-to-add indication comprises establishing the application layer communication tunnel with the UAV based on the first transport layer address, the first port number, the second transport layer address, and the second port number.

Example 14. The method of any of methods 10-13, wherein the command request comprises a tunnel-to-release indication or an indication of a number of tunnels to release.

Example 15. The method of any of methods 10-14, wherein the command response comprises a tunnel-to-release indication or an indication of a number of tunnels to release.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations 500, 600a, 600b, 600c, and 700 may be substituted for or combined with one or more operations of the methods and operations 500, 600a, 600b, 600c, and 700.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processor of an unmanned aerial vehicle (UAV) for managing communication with an unmanned aerial vehicle controller (UAC), comprising:
receiving from an unmanned aerial system traffic management (UTM) device a command request from the UAC, the command request comprising one or more destination Generic Public Subscription Identifiers (GPSIs), a control command, a data command, and a first tunnel-to-add indication;
sending to the UAC via the UTM device a command response, the command response comprising information responsive to the command request, and a second tunnel-to-add indication; and
establishing an application layer communication tunnel with the UAC based on the first tunnel-to-add indication and the second tunnel-to-add indication, wherein the application layer communication tunnel is configured to enable further communications with the UAC.

2. The method of claim 1, wherein the control command comprises a movement time and a movement type.

3. The method of claim 2, further comprising executing the control command based on the movement time and movement type.

4. The method of claim 1, wherein the data command comprises a data capture time, a data capture type, and a sensor type.

5. The method of claim 4, further comprising capturing data based on the data capture time, the data capture type, and the sensor type.

6. The method of claim 1, wherein:
the first tunnel-to-add indication comprises a first transport layer address and a first port number, and wherein the second tunnel-to-add indication comprises a second transport layer address and a second port number; and
establishing an application layer communication tunnel with the UAC based on the first tunnel-to-add indication and the second tunnel-to-add indication comprises establishing the application layer communication tunnel with the UAC based on the first transport layer address, the first port number, the second transport layer address, and the second port number.

7. The method of claim 1, wherein establishing an application layer communication tunnel with the UAC based on the first tunnel-to-add indication and the second tunnel-to-add indication comprises:
capturing data based on the data command;
establishing the application layer communication tunnel with the UAC based on the first tunnel-to-add indication and the second tunnel-to-add indication; and
sending to the UAC the captured data via the established application layer communication tunnel.

8. The method of claim 1, wherein the command request comprises a tunnel-to-release indication.

9. The method of claim 1, wherein the command response comprises a tunnel-to-release indication.

10. A method performed by a processor of an unmanned aerial vehicle controller (UAC) for managing communication with an unmanned aerial vehicle (UAV), comprising:
sending to an unmanned aerial system traffic management (UTM) device a command request for the UAV, the command request comprising a destination Generic Public Subscription Identifier (GPSI) list, a control command, a data command, and a first tunnel-to-add indication;
receiving from the UTM device a command response from the UAV, the command response comprising information responsive to the command request, and a second tunnel-to-add indication; and
establishing an application layer communication tunnel with the UAV based on the first tunnel-to-add indication and the second tunnel-to-add indication, wherein the application layer communication tunnel is configured to enable further communications with the UAV.

11. The method of claim 10, wherein the control command comprises a movement time and a movement type.

12. The method of claim 10, wherein the data command comprises a data capture time, a data capture type, and a sensor type.

13. The method of claim 10, wherein:
The first tunnel-to-add indication comprises a first transport layer address and a first port number, and wherein the second tunnel-to-add indication comprises a second transport layer address and a second port number; and
establishing an application layer communication tunnel with the UAV based on the first tunnel-to-add indication and the second tunnel-to-add indication comprises establishing the application layer communication tunnel with the UAV based on the first transport layer address, the first port number, the second transport layer address, and the second port number.

14. The method of claim 10, wherein the command request comprises a tunnel-to-release indication.

15. The method of claim 10, wherein the command request comprises an indication of a number of tunnels to release.

16. The method of claim 10, wherein the command response comprises a tunnel-to-release indication.

17. The method of claim 10, wherein the command response comprises an indication of a number of tunnels to release.

18. An unmanned aerial vehicle (UAV), comprising:
a processor configured with processor executable instructions to:
receive from an unmanned aerial system traffic management (UTM) device a command request from an unmanned aerial vehicle controller (UAC), the command request comprising one or more destination Generic Public Subscription Identifiers (GPSIs), a control command, a data command, and a first tunnel-to-add indication;
send to the UAC via the UTM device a command response, the command response comprising information responsive to the command request, and a second tunnel-to-add indication; and
establish an application layer communication tunnel with the UAC based on the first tunnel-to-add indication and the second tunnel-to-add indication, wherein the application layer communication tunnel is configured to enable further communications with the UAC.

19. The UAV of claim 18, wherein:
the control command comprises a movement time and a movement type; and
the processor is further configured with processor executable instructions to execute the control command based on the movement time and movement type.

20. The UAV of claim 18, wherein:
the control command comprises a movement time and a movement type;
the data command comprises a data capture time, a data capture type, and a sensor type; and
the processor is further configured with processor executable instructions to capture data based on the data capture time, the data capture type, and the sensor type.

21. The UAV of claim 18, wherein:
the first tunnel-to-add indication comprises a first transport layer address and a first port number;
the second tunnel-to-add indication comprises a second transport layer address and a second port number; and
the processor is further configured with processor executable instructions to establish an application layer communication tunnel with the UAC based on the first tunnel-to-add indication and the second tunnel-to-add indication by establishing the application layer communication tunnel with the UAC based on the first transport layer address, the first port number, the second transport layer address, and the second port number.

22. The UAV of claim 18, wherein the processor is configured with processor executable instructions to establish an application layer communication tunnel with the UAC based on the first tunnel-to-add indication and the second tunnel-to-add indication by:
capturing data based on the data command;
establishing the application layer communication tunnel with the UAC based on the first tunnel-to-add indication and the second tunnel-to-add indication; and
sending to the UAC the captured data via the established application layer communication tunnel.

23. An unmanned aerial vehicle controller (UAC), comprising:
a processor configured with processor executable instructions to:
send to an unmanned aerial system traffic management (UTM) device a command request for an unmanned aerial vehicle (UAV), the command request comprising a destination Generic Public Subscription Identifier (GPSI) list, a control command, a data command, and a first tunnel-to-add indication;
receive from the UTM device a command response from the UAV, the command response comprising information responsive to the command request, and a second tunnel-to-add indication; and
establish an application layer communication tunnel with the UAV based on the first tunnel-to-add indication and the second tunnel-to-add indication, wherein the application layer communication tunnel is configured to enable further communications with the UAV.

24. The UAC of claim 23, wherein the processor is configured with processor executable instructions to send to the UTM device a command request for the UAV, the command request comprising a destination GPSI list, a control command, a data command, and a first tunnel-to-add indication in which the control command comprises a movement time and a movement type.

25. The UAC of claim 23, wherein the processor is configured with processor executable instructions to send to the UTM device a command request for the UAV, the command request comprising a destination GPSI list, a control command, a data command, and a first tunnel-to-add indication in which the data command comprises a data capture time, a data capture type, and a sensor type.

26. The UAC of claim 23, wherein the processor is configured with processor executable instructions to perform operations such that:
The first tunnel-to-add indication comprises a first transport layer address and a first port number, and wherein the second tunnel-to-add indication comprises a second transport layer address and a second port number; and
establishing an application layer communication tunnel with the UAV based on the first tunnel-to-add indication and the second tunnel-to-add indication comprises establishing the application layer communication tunnel with the UAV based on the first transport layer address, the first port number, the second transport layer address, and the second port number.

27. The UAC of claim 23, wherein the processor is configured with processor executable instructions to send to the UTM device a command request for the UAV, the command request comprising a destination GPSI list, a control command, a data command, and a first tunnel-to-add indication in which the command request comprises a tunnel-to-release indication.

28. The UAC of claim 23, wherein the processor is configured with processor executable instructions to send to the UTM device a command request for the UAV, the command request comprising a destination GPSI list, a control command, a data command, and a first tunnel-to-add indication in which the command request comprises an indication of a number of tunnels to release.

29. The UAC of claim 23, wherein the processor is configured with processor executable instructions to send to the UTM device a command request for the UAV, the command request comprising a destination GPSI list, a control command, a data command, and a first tunnel-to-add indication in which the command response comprises a tunnel-to-release indication.

30. The UAC of claim 25, wherein the processor is configured with processor executable instructions to send to the UTM device a command request for the UAV, the command request comprising a destination GPSI list, a control command, a data command, and a first tunnel-to-add indication in which the command response comprises an indication of a number of tunnels to release.
